(19) United States
(12) Patent Application Publication
(10) Pub. No.: US 2024/0150168 A1
(43) Pub. Date: May 9, 2024

(54) Combined cleaning unit for e-plants

(71) Applicant: TOPSOE A/S, Kgs. Lyngby (DK)

(72) Inventors: Emil Andreas TJÄRNEHOV, Limhamn (SE); Pat A. Han, Smørum (DK); Lari Bjerg Knudsen, Kastrup (DK)

(73) Assignee: TOPSOE A/S, Kgs. Lyngby (DK)

(21) Appl. No.: 18/280,256

(22) PCT Filed: Mar. 22, 2022
(86) PCT No.: PCT/EP2022/057433

§ 371 Date: Sep. 4, 2023

(30) Foreign Application Priority Data
Mar. 22, 2021 (EP) 21164059.4

(51) Int. Cl. C01B 3/02; C25B 1/04; C25B 1/34

(52) U.S. Cl. CPC C01B 3/025; C25B 1/04; C25B 1/34; C01B 2203/04; C01B 2203/061; C01B 2203/068

(57) ABSTRACT

The present invention refers to a process, a system and a plant for producing synthesis gas, comprising a combined cleaning unit for hydrogen and CO₂ or hydrogen and N₂. The process, system and plant of the present invention provide significant savings and improved CAPEX in e-plants for producing ammonia, methanol and other e-fuels.

### FIELD OF APPLICATION

The present invention refers to a process, a system and a plant for producing synthesis gas, comprising a combined cleaning unit for 1) hydrogen provided preferably by electrolysis and 2) captured CO₂ or 3) N₂ provided by an air separation unit, PSA or membrane.

### BACKGROUND ART

Hydrogen (H₂) from electrolysis may contain impurities, such as O₂, H₂O, KOH or other, which are usually unwanted e.g. in the synthesis of e-fuels (methanol (MeOH), methane (CH₄), ammonia (NH₃) etc.). These are typically removed by a cleaning unit in order to achieve a close to pure H₂ feedstock. The same applies to CO₂ and N₂, CO₂ from various carbon capture solutions may contain O₂, H₂O, sulfur, NOx or other catalyst poisons which must be removed before (or inside) the synthesis loop. N₂ may contain O₂ which also needs to be removed before ammonia synthesis.

If hydrogen is produced at low pressure, i.e. close to atmospheric pressure, approximately 0.1 bar g, it is compressed into the required pressure or the required synthesis pressure, which for MeOH applications is approximately 50-100 bar g and for NH₃ applications, is approximately 100-300 bar g. If CO₂ or N₂ are produced at low pressure (e.g., 0.3-1.0 bar g for CO₂) they may be compressed into the required pressure, if necessary.

The standard solution (FIGS. 1 and 2) therefore typically comprises a separate cleaning unit for H₂ and for CO₂ or N₂ and also a separate compressor for H₂ and for CO₂ or N₂.

Any oxygen containing compound will be a poison to ammonia synthesis catalysts, which is why the specification of the hydrogen and nitrogen purity are normally very strict. In hydrogen production based on electrolysis, a gas clean-up system will typically be required. In nitrogen production, the high purity demand will make the system costlier and/or less energy efficient.

FIGS. 1 and 2 show an example for said standard solution, where H₂ is generated in an electrolyser from renewable power and water, i.e., a traditional design with an electrolyser, a compression unit, a cleaning unit (e.g. de-oxo unit) and a dryer. The expected ramp-up capacity when using alkaline electrolysis is between 3-20%/minute, preferably 5-15%/minute, most preferably about 10%/minute to obtain an acceptable purity of H₂ feed, i.e. raw hydrogen 1000-2000 ppm O₂ in H₂ (a faster operation will give more oxygen in H₂). However, the present invention provides for the improvement of ramp-up capacity, regardless of the unit (A) used for providing a stream comprising hydrogen.

Nitrogen (N₂) is generated e.g. in an air separation unit (ASU). Due to the O₂ requirement in the gas sent to synthesis, the air separation unit is producing high purity N₂, i.e. approximately 99.9-99.999% pure, or alternatively using a de-oxo unit on N₂ as well.

### SUMMARY OF THE INVENTION

The present invention (FIGS. 3, 4 and 5) provides for an improvement to the standard known solutions described above (FIGS. 1 and 2), by combining the streams (H₂+CO₂ or H₂+N₂) allowing the streams to be cleaned in one single unit, in particular a common cleaning unit (E) for the H₂+CO₂ lines or the H₂+N₂ lines. Furthermore, in a preferred embodiment said combined streams are compressed in a compression unit (G) which may be integrated with the combined cleaning unit (E).

The present invention provides for the reduction of the number of cleaning units and other equipment such as compressing units in a plant, thereby improving/reducing CAPEX.

FIGS. 3 and 4 show preferred embodiments of the present invention, where hydrogen is generated preferably in an electrolyser from renewable power and water. Hydrogen is delivered without purification. Ramp-up capacity is thereby increased as we can allow for a higher oxygen content in H₂.

Nitrogen is preferably generated in an air separation unit (ASU) or membrane. Due to the common cleaning unit designed to handle high content of oxygen and other impurities, an air separation unit, PSA or membrane for N₂ with low purity may be selected (thereby again optimizing CAPEX). The new fast ramp-up capacity is allowing the electrolyser to match the variations in the electrical grid still producing H₂. The H₂ is less clean but a common de-oxo cleaning unit (E) is designed to handle the higher concentration of oxygen, as well as of other impurities present.

### BRIEF DESCRIPTION OF DRAWINGS

FIG. 1 shows standard generation of H₂ and CO₂ streams for synthesizing e-methanol, e-methane and other e-fuels, where compression (D) and cleaning (E) are made separately for each stream (4) and (8).

FIG. 2 shows standard generation of H₂ and N₂ for synthesizing green ammonia, where compression (D) and cleaning (E) are made separately for each stream (4) and (12).

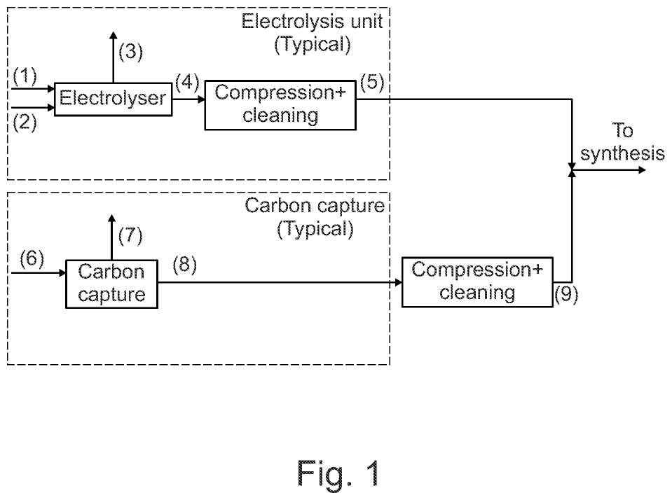

FIG. 3 shows a preferred embodiment of the present invention for both,
1) generation of H₂ and CO₂ streams (5,9) for synthesizing e-methanol, e-methane and other e-fuels or
2) generation of H₂ and N₂ streams (5,13) for synthesizing green ammonia,
where compression step (D) may or not be performed separately (optional), upstream to a joint cleaning (E) step (d) for a combined stream of H₂ and CO₂ (4,8) or H₂ and N₂ (4,12).

FIG. 4 shows another preferred embodiment of the present invention for both,
1) generation of H₂ and CO₂ streams (5,9) for synthesizing e-methanol, e-methane and other e-fuels or
2) generation of H₂ and N₂ streams (5,13) for synthesizing green ammonia,
where compression step (D) may or not be performed separately (optional), upstream to a cleaning (E) step (d) and a compression (G) of a combined stream of H₂ and CO₂ (4,8) or H₂ and N₂ (4,12) is performed downstream to, or inter-staged with, the cleaning step (d).

FIG. 5 shows a representation of Example 1.

### REFERENCE NUMBERS IN FIGURES

(1) Power, preferably renewable power
(2) H₂O
(3) O₂
(4) H₂ and impurities (e.g. H₂O, O₂, KOH)
(5) H₂ (pure, saturated with H₂O and O₂)
(6) Flue gas or pressurized syngas
(7) CO₂ depleted flue gas/syngas
(8) CO₂ and impurities (e.g. H₂O, O₂ and other)
(9) CO₂
(10) Air
(11) N₂ depleted air
(12) N₂ with impurities (e.g. O₂, Ar)
(13) N₂ and Ar
A—Electrolyser
A′—Hydrogen Scrubbing Unit
B—Carbon Capture Unit (CC)
C—Air Separation Unit (ASU)
D—Compression unit
E—Cleaning unit (e.g. Catalyzing unit such as a De-oxo unit)
F—Drying unit, for removal of H₂O
G—Compression unit, for combined stream of H₂ and CO₂ or H₂ and N₂

### Definitions

“Alkaline electrolyzers” operate via transport of hydroxide ions (OH—) through the electrolyte from the cathode to the anode with hydrogen being generated on the cathode side. Electrolyzers using a liquid alkaline solution of sodium or potassium hydroxide as the electrolyte have been commercially available for many years.

“Atmospheric pressure” means 1,01325 bar, i.e., approximately 1 bar.

“Air separation” separates atmospheric air into its primary components, typically nitrogen and oxygen, and sometimes also argon and other rare inert gases. The most common method for air separation is fractional distillation. Cryogenic air separation units (ASUs) are built to provide nitrogen or oxygen and often co-produce argon. Other methods such as membrane, pressure swing adsorption (PSA) and vacuum pressure swing adsorption (VPSA) are commercially used to separate a single component from ordinary air.

“Carbon capture” means the method of capturing carbon dioxide from a stream, typically flue gas but also from pressurized process gas. The method consists of an absorber where a liquid sorbent is in contact with the gas and selectively absorbs the CO₂. The CO₂ loaded sorbent is sent to a stripper where the loaded CO₂ is stripped off by use of heat so that the CO₂ is leaving the stripper in concentrated form.

“Carbon capture unit” means the process unit where the carbon capture takes place, i.e CO₂ production unit from flue gas.

“CAPEX” or Capital expenditures are funds used by a company to acquire, upgrade, and maintain physical assets such as property, plants, buildings, technology, or equipment.

The “chloralkali process” (also called chlor-alkali and chlor alkali) is an industrial process for the electrolysis of sodium chloride solutions. It is the technology used to produce chlorine and sodium hydroxide (lye/caustic soda), which are commodity chemicals required by industry. The chlorine and sodium hydroxide produced in this process are widely used in the chemical industry. Usually the process is conducted on a brine (an aqueous solution of NaCl), in which case NaOH, hydrogen, and chlorine result. When using calcium chloride or potassium chloride, the products contain calcium or potassium instead of sodium. Related processes are known that use molten NaCl to give chlorine and sodium metal or condensed hydrogen chloride to give hydrogen and chlorine.

The process has a high energy consumption, for example around 2500 kWh of electricity per tonne of sodium hydroxide produced. For every mole of chlorine produced, one mole of hydrogen is produced.

Three production units for the chloralkali process are typically in use: membrane cell, diaphragm cell and mercury cell.

“Cleaning Step” (d) refers to removal of impurities, either by converting them catalytically to other components that can be removed down-stream (O₂ converted to H₂O which is separated downstream in the process) or alternatively adsorbing the impurities on an adsorbent (sulfur adsorbed to catalyst in the cleaning step).

“Cleaning unit” is the process unit where the cleaning step takes place. Comprises one or more reactors where impurities are adsorbed or converted.

“Compression” means increasing a pressure of a gas by reducing its volume. Compression (D) is conducted prior to mixing of the two gases (H₂ and N₂ or H₂ and CO₂) thereby avoiding to reduce the pressure of the gas with the highest pressure in place. Compression (G) is the compression of the combined gases up to required synthesis pressure.

“Compression unit” is the process unit where compression takes place. A compressor is a mechanical device that increases the pressure of a gas by reducing its volume. Gas is compressed in single or multiple stages. The compression unit comprises interstage coolers and K.O drums (separators) for multiple stages.

“De-oxo unit” is a catalytic bed or catalyzing unit operating at elevated temperature, approximately 20 to 200° C., where the reaction 2H₂+O₂->H₂O takes place.

“Dryer unit” could be a simple condensation stage (at high pressure after final syngas compressor) alternatively a mol sieve bed.

“E-fuels” may be carbon based or non-carbon based. E-fuels or synthetic fuels or carbon-neutral replacement fuels, are made by storing electrical energy from renewable sources in the chemical bonds of liquid or gas fuels.

“Electrolysis of water” is a promising option for hydrogen production from renewable resources. It is the process of using electricity to split water into hydrogen and oxygen. This reaction takes place in a unit called an electrolyzer. Electrolysis could mean any type of electrolysis, in particular PEM (Polymer Electrolyte Membrane), alkaline electrolysis or SOEC (Solid Oxide Electrolysis Cells).

“Electrolyzers” can range in size from small, appliance-size equipment that is well-suited for small-scale distributed hydrogen production to large-scale, central production facilities that could be tied directly to renewable or other non-greenhouse-gas-emitting forms of electricity production. Electrolyzers consist of an anode and a cathode separated by an electrolyte. Different electrolyzers function in slightly different ways, mainly due to the different type of electrolyte material involved.

“Flue gas” is the gas exiting to the atmosphere via a flue, which is a pipe or channel for conveying exhaust gases from a fireplace, oven, furnace, boiler or steam generator. Flue gas refers to the combustion exhaust gas produced at power plants. Its composition depends on what is being burned, but it will usually consist of mostly nitrogen (typically more than two-thirds) derived from the combustion of air, carbon dioxide (CO2), and water vapor as well as excess oxygen (also derived from the combustion air). It further contains a small percentage of a number of pollutants, such as particulate matter (like soot), carbon monoxide, nitrogen oxides, and sulfur oxides.

“High-pressure electrolysis (HPE)” is the electrolysis of water by decomposition of water (H₂O) into oxygen (O₂) and hydrogen gas (H₂) due to the passing of an electric current through the water. The difference with a standard proton exchange membrane electrolyzer is the compressed hydrogen output around 12-20 megapascals (120-200 bar) at about 70° C. By pressurizing the hydrogen in the electrolyzer the need for an external hydrogen compressor is eliminated, the average energy consumption for internal differential pressure compression is around 3%.

“Hydrogen scrubbing” means the process through which the hydrogen stream, which comprises droplets of KOH, is cleaned with water. The contact of KOH entrainment in droplets with the water will ensure a hydrogen product saturated with water and KOH entrainment. A hydrogen scrubber is the unit where the hydrogen stream is cleaned using water. The hydrogen stream having KOH typically enters in the bottom of the scrubber and passes through trays or packing, where water is used as scrubbing solution.

“Inter-stage” means a step or operation taking place in between 2 compression stages (e.g., cleaning in a de-oxo unit).

In a “Polymer electrolyte membrane” (PEM) electrolyzer, the electrolyte is a solid specialty plastic material. Water reacts at the anode to form oxygen and positively charged hydrogen ions (protons). The electrons flow through an external circuit and the hydrogen ions selectively move across the PEM to the cathode. At the cathode, hydrogen ions combine with electrons from the external circuit to form hydrogen gas. Anode Reaction: 2H2O→O2+4H++4e−; Cathode Reaction: 4H++4e−→2H2.

Power or energy for generating hydrogen by electrolysis is preferably “renewable energy” such as hydro, solar, wind, geothermal and wave energy but may also be partially or entirely non-renewable power such as nuclear, natural gas based, coal base or other.

“Pressure”, P, means gauge pressure and is measured in bar g. Gauge pressure is the pressure relative to atmospheric pressure and it is positive for pressures above atmospheric pressure, and negative for pressures below it. The difference between bar and bar g is the difference in the reference considered. Measurement of pressure is always taken against a reference and corresponds to the value obtained in a pressure measuring instrument. If the reference in the pressure measurement is vacuum we obtain absolute pressure and measure it in bar only. If the reference is atmospheric pressure then pressure is cited in bar g.

“PSA” or “Pressure Swing Adsorption” is a technology used to separate some gas species from a mixture of gases under pressure according to the species' molecular characteristics and affinity for an adsorbent material. It operates at near-ambient temperatures and differs significantly from cryogenic distillation techniques of gas separation. Specific adsorbent materials (e.g., zeolites, activated carbon, molecular sieves, etc.) are used as a trap, preferentially adsorbing the target gas species at high pressure. The process then swings to low pressure to desorb the adsorbed material.

Pressure swing adsorption processes utilize the fact that under high pressure, gases tend to be attracted to solid surfaces, or “adsorbed”. The higher the pressure, the more gas is adsorbed. When the pressure is reduced, the gas is released, or desorbed. PSA processes can be used to separate gases in a mixture because different gases tend to be attracted to different solid surfaces more or less strongly. If a gas mixture such as air is passed under pressure through a vessel containing an adsorbent bed of zeolite that attracts nitrogen more strongly than oxygen, part or all of the nitrogen will stay in the bed, and the gas exiting the vessel will be richer in oxygen than the mixture entering. When the bed reaches the end of its capacity to adsorb nitrogen, it can be regenerated by reducing the pressure, thus releasing the adsorbed nitrogen. It is then ready for another cycle of producing oxygen-enriched air.

“Pure H₂ feedstock” means approximately pure hydrogen, such as 99.9-99.9999% H₂

“Ramp-up capacity” means the speed for changing the capacity, commonly measured in %/sec or %/min.

“Renewable Energy” or Power is useful energy that is collected from renewable resources, which are naturally replenished on a human timescale, including carbon neutral sources like sunlight, wind, rain, tides, waves, and geothermal heat. The term often also encompasses biomass as well, whose carbon neutral status is under debate. This type of energy source stands in contrast to fossil fuels, which are being used far more quickly than they are being replenished. Renewable energy often provides energy in four important areas: electricity generation, air and water heating/cooling, transportation, and rural (off-grid) energy services.

“Solid oxide electrolyzers” use a solid ceramic material as the electrolyte that selectively conducts negatively charged oxygen ions (O₂—) at elevated temperatures, generating hydrogen. Water at the cathode combines with electrons from the external circuit to form hydrogen gas and negatively charged oxygen ions. The oxygen ions pass through the solid ceramic membrane and react at the anode to form oxygen gas and generate electrons for the external circuit.

Solid oxide electrolyzers must operate at temperatures high enough for the solid oxide membranes to function properly (about 700°-800° C., compared to PEM electrolyzers, which operate at 70°-90° C., and commercial alkaline electrolyzers, which operate at 100°-150° C.). The solid oxide electrolyzers can effectively use heat available at these elevated temperatures (from various sources, including nuclear energy) to decrease the amount of electrical energy needed to produce hydrogen from water.

“Synthesis gas” or Syngas is a fuel gas mixture consisting primarily of hydrogen, carbon monoxide, and very often some carbon dioxide. The name comes from its use as intermediates in creating synthetic natural gas (SNG) and for producing ammonia or methanol. Syngas is usually a product of coal gasification and the main application is electricity generation. Syngas is combustible and can be used as a fuel of internal combustion engines. Syngas can be produced from many sources, including natural gas, coal, biomass, or virtually any hydrocarbon feedstock, by reaction with steam (steam reforming), carbon dioxide (dry reforming) or oxygen (partial oxidation). It is a crucial intermediate resource for production of hydrogen, ammonia, methanol, and synthetic hydrocarbon fuels. It is also used as an intermediate in producing synthetic petroleum for use as a fuel or lubricant via the Fischer-Tropsch process. Production methods include steam reforming of natural gas or liquid hydrocarbons to produce hydrogen, the gasification of coal, biomass, and in some types of waste-to-energy gasification facilities.

### DESCRIPTION OF THE INVENTION

The present invention refers to a process, a system and a plant for producing synthesis gas, comprising a combined cleaning unit for hydrogen provided by electrolysis and captured CO 2 or hydrogen provided by electrolysis and N₂ provided by an air separation unit or membrane. Furthermore, in a preferred embodiment said combined streams of H₂ and CO₂ or H₂ and N₂ are compressed in a combined unit (G) which may or not be integrated or interstaged with the combined cleaning unit (E).

FIGS. 3 and 4 show embodiments of the present invention which provide for a common gas purification step to remove oxygen from the hydrogen and nitrogen streams. This will allow for use of less costly Air Separation Unit for production of nitrogen and allow savings on the electrolysis system since the typical gas clean-up unit on the hydrogen stream will not be required.

The synthesis gas production comprises a direct hydrogen stream from the electrolysis stacks that will be mixed with a less pure nitrogen stream in the fixed ratio of 3:1, feeding one synthesis gas compressor. Interstage the synthesis gas compressor, oxygen will be removed by a catalyzed reaction with hydrogen to form water. Most water will be knocked out in the interstage cooling and separation, and the water saturated synthesis gas entering the ammonia loop will be washed by condensed ammonia product and leave the loop dissolved in the liquid ammonia product.

Having a design more stable and dynamic than the standard solutions available so far, will allow for a simple and cost-efficient design comprising a single compressor having suction directly to the electrolysers without a dedicated hydrogen storage to smoothing out the fluctuating hydrogen production.

The nitrogen production unit will have a small gaseous nitrogen storage, which will serve several purposes such as feeding the synthesis, safety purge gas for the electrolysers and plant nitrogen.

### 1—Electrolysis

There are different electrolyser types and they have different capacity ramp up speeds. A fast ramping up capacity is highly attractive as it is possible to balance the power grid (if a large electric user is shut down there is a need to send this electric load elsewhere). We know that for alkaline electrolysers this ramp up speed is limited by purity (oxygen being an impurity) of the hydrogen product and we believe that manipulating the ramp up speed is not sufficient.

By tailoring the “cleaning unit” (E) for withstanding a higher oxygen concentration, the electrolyser can absorb these electric variations (which have a monetary value associated) and the hydrogen product is cleaned from oxygen afterwards. So the hydrogen production does not need to follow or depend on the electric load variations (as part of the hydrogen is consumed in the cleaning process), but the electrolyser (as well as the whole system and plant of the present invention) can operate with and handle these fast transitions.

### 4—Cleaning

With a combined cleaning unit (E) we can also allow for a “lower grade”, less pure nitrogen/N₂ (or carbon dioxide/CO₂) than in the standard solution, which will provide a lower CAPEX for this unit. An example is the nitrogen used in production of green ammonia, where said nitrogen is to be produced from Pressure Swing Adsorption (PSA).

The nitrogen purity (oxygen content) and unit cost comes in different steps and with a single cleaning unit we can optimize the overall solution, reducing operation costs.

The cleaning unit (E) comprises a catalyzing unit, such as a de-oxo unit but may also comprise other combined cleaning units such as desulfurizing unit or other.

By having a combined cleaning unit we “dilute” the hydrogen with more N₂ (alternatively CO₂) which acts as buffer on the temperature increase, when removing the oxygen—other impurities are removed but this temperature effect results from oxygen. That means that the temperature increase for this diluted case is lower and a higher oxygen concentration can be allowed for a specific design of the present invention, as shown in FIGS. 3, 4 and 5.

### 5—Compression

Compression in unit (D) is optional and may be useful when at least one of the two streams (4,8,12) are at too low pressure. Compression in unit (D) may comprise multiple compression stages.

Cleaning step d) can be interstaged with compression in unit (G) or after compression in unit (G), wherein this compression step at unit G may comprise multiple compression stages.

### EXAMPLES

### Example 1—Producing Green Ammonia Using Combined Cleaning and Compression with Pressurized Alkaline Electrolysis, without Compression on H₂ Stream

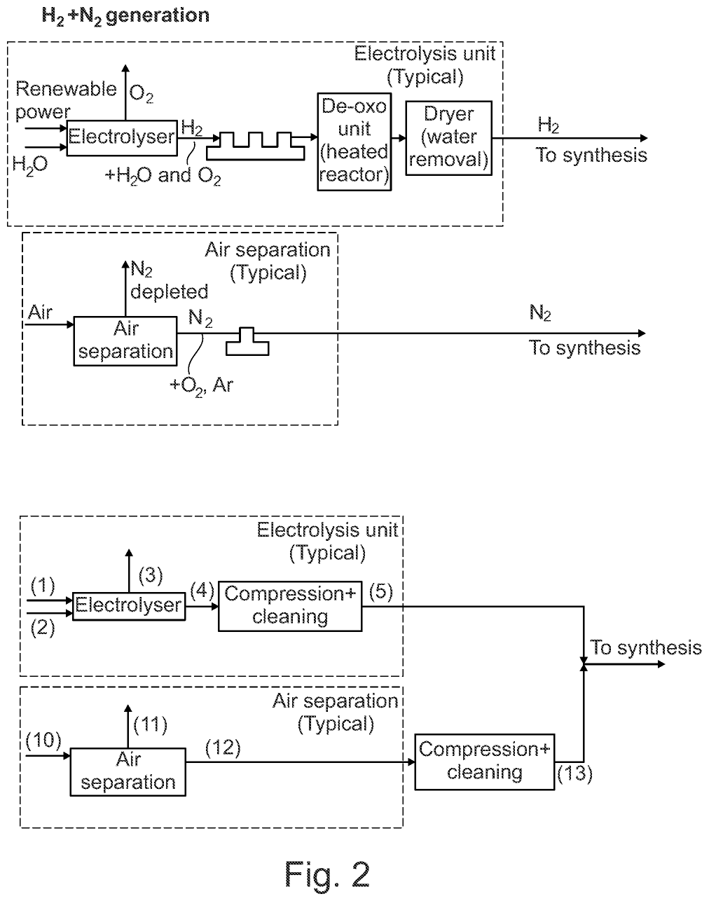

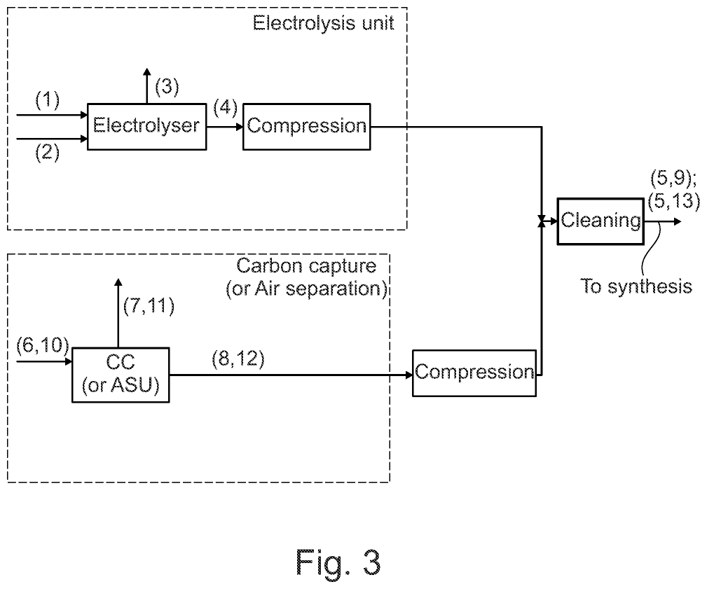

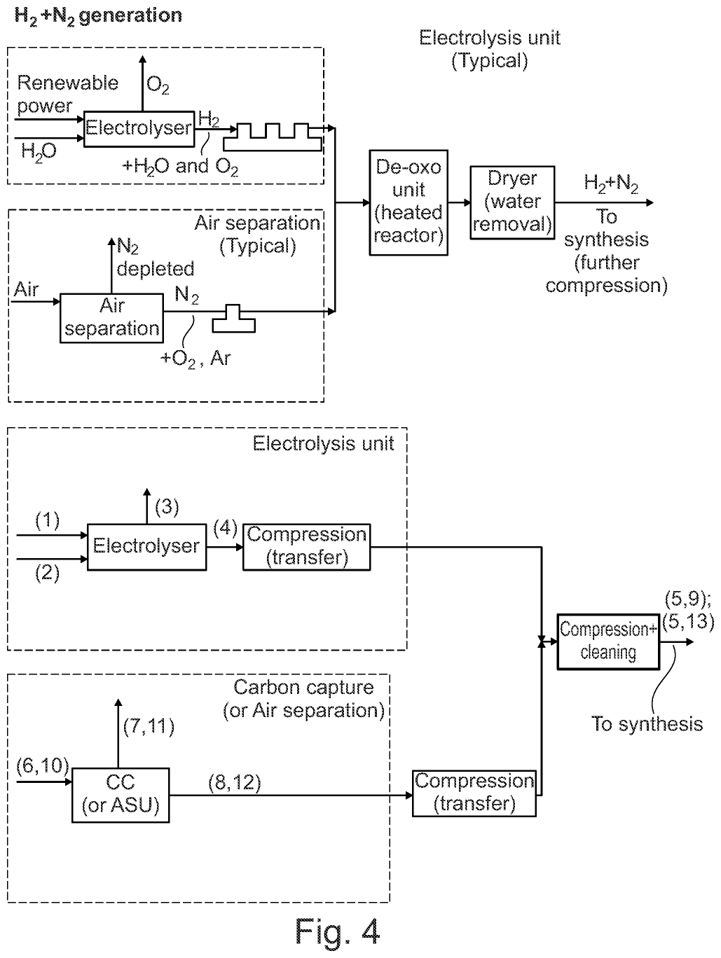

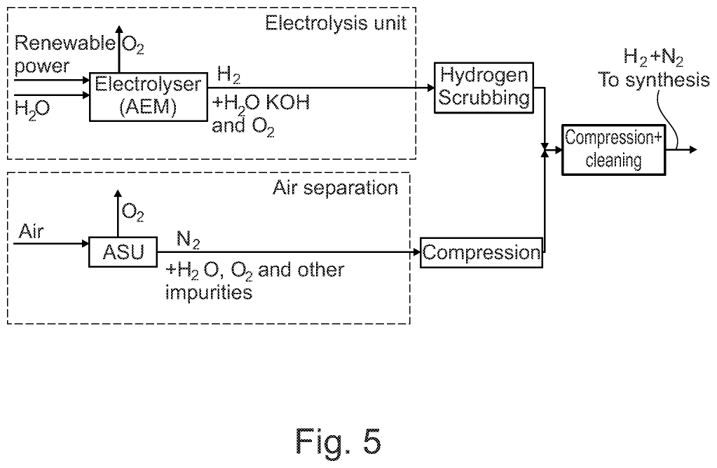

When using a standard solution such as the one in FIG. 2, we observed the following limitations:
Electrolyser had to deliver pure H₂ which required a de-oxo unit and sometimes a dryer unit;
Hydrogen was compressed in a separate compressor;
N₂ from ASU (cryogenic) was of high purity and was compressed in a separate compressor.

By using the solution provided in the present invention we observed:
Pressurized alkaline electrolysis delivered hydrogen at approx. 20 bar g;
Hydrogen scrubber removed KOH from the hydrogen stream;
Cryogenic ASU: No strict requirement on nitrogen purity as we had cleaning downstream;
N₂ was pressurized to approx. 20 bar g in separate compressor before mixing (separate compression to 20 bar g to save energy by not losing H₂ pressure);
The mixed stream was sent to a compressor (multiple stages) which had a cleaning step interstaged;
Cleaning was performed by catalytic removal of oxygen (to water) and water was then removed in the interstaged knock out drums.

The advantages of using the present invention in this particular example (FIG. 5) were:
Combined compression/combined cleaning—providing savings in CAPEX (total number of compressors was reduced);
Less strict requirement for N₂ purity—providing savings in CAPEX (either less costly ASU or no requirement for cleaning of N₂);
Overall allowable content of O₂ (impurity) could be increased;
Cleaning of both streams allowed us to control the overall O₂ content to the synthesis; and
Interstaged position of the cleaning step removed the requirement of a heater.

### Preferred Embodiments

1. Process for producing synthesis gas comprising the steps of:
   (a) providing a stream (4) comprising hydrogen;
   (b) providing a stream (8) comprising carbon dioxide or a stream (12) comprising nitrogen;
   (c) combining the streams obtained in steps a) and b) into streams (4,8) or (4,12); and (d) cleaning said combined streams.

Feed H₂ (4) may be at atmospheric pressure.

Feed CO₂ (8) may be at 0-3 bar g and feed N₂ (12) may be at 0-5 bar g and may not require compression before cleaning stage.

Impurities in step a) may comprise KOH (in alkaline electrolysis), Cl, oxygen and water.

Impurities in step b) may comprise oxygen, water, sulfur compounds, NOx and other catalyst poisons.

Cleaning step d) may be performed at very low pressures (with minimum compression of each feed before combining them) or at medium pressure, e.g. 10-20 bar g. If, for example, combined streams of step (c) are pressurized to about 10 barg for cleaning, it allows the operation to be more dynamic, by removing the impurities in a common unit and save CAPEX.
2. Process according to embodiment 1, wherein combined streams (4,8) or (4,12) are subjected to a compression step (G).

Pressurizing the combined streams to synthesis pressure could mean different ranges. For example, for synthesizing methanol such range may be for example 60-100 bar g and for synthesizing ammonia this could be a different range, such as for example 100-300 bar g.
3. Process according to any one of embodiments 1 or 2, wherein compression step (G) comprises multiple compression stages.
4. Process according to embodiment 3 wherein the cleaning step (d) is performed between compression stages of the compression step (G).
5. Process according to embodiment 3 wherein the cleaning step (d) is performed after the last compression stage of compression step (G).
6. Process according to any one of embodiments 1 to 5, wherein the streams obtained in steps (a) and (b) are independently subjected to a compression (D) step, before being combined in step (c).
7. Process according to embodiment 6, wherein compression step (D) comprises multiple compression stages.
8. Process according to any one of embodiments 1 to 7, wherein stream (4) is prepared by electrolysis of water.
9. Process according to embodiment 8 wherein electrolysis of water uses renewable power, such as hydro, solar, wind, geothermal and wave energy.
10. Process according to any one of embodiments 1 to 9, further comprising a hydrogen scrubbing step (a′), integrated with or downstream to step (a).
11. Process according to any one of embodiments 1 to 10, wherein stream (8) is prepared by carbon capture of flue gas or synthesis gas.
12. Process according to any one of embodiments 1 to 10, wherein stream (12) is prepared using air separation.

Air separation unit (C) may be, e.g., an air separation membrane, Cryogenic ASU or pressure swing adsorption (PSA).
13. Process for producing carbon based and/or non-carbon based e-fuels from synthesis gas made according to any one of embodiments 1-12.
14. Process according to embodiment 13 wherein carbon-based e-fuels are methane, methanol, gasoline, DME, diesel and jet fuel.

Methanol obtained according to the method of the present invention may be used as a base chemical for manufacturing other chemicals (e.g. formaldehyde, MTO and other chemicals typically obtained from methanol).
15. Process according to embodiment 13 wherein non-carbon based e-fuels are preferably ammonia.

Ammonia obtained according to the process of the present invention may be used as a fertilizer or for other common uses typically given to ammonia (e.g. as stabilizer or neutralizer in industry, in the composition of household products or other).
16. System for producing synthesis gas comprising:
a) a unit (A) for providing a stream (4) comprising hydrogen;
b) a carbon capture unit (B) for providing a stream (8) comprising carbon dioxide or an air separation unit (C) for providing a stream (12) comprising nitrogen;
c) a cleaning unit (E) for removal of impurities from combined streams (4,8) or (4,12).

The cleaning unit (E) is designed to allow more impurities and thereby a higher fluctuation on the load of the electrolyzer.
17. System according to embodiment 16 wherein said unit (A) is an electrolyzer.
18. System according to embodiment 17 wherein the electrolyzer is a high-pressurized electrolyser.
19. System according to embodiment 16 wherein said unit (A) is a unit for performing chloralkali process.
20. System according to any one of embodiments 16 to 19, wherein a compression unit (D) is upstream to the cleaning unit (E).
21. System according to embodiment 20, wherein compression unit (D) comprises multiple compression stages.
22. System according to any one of embodiments 16 to 21, wherein a cleaning unit (E) is integrated with a compression unit (G).
23. System according to any one of embodiments 16 to 21, wherein a cleaning unit (E) is arranged downstream to the last compression stage of compression unit (G).
24. System according to any one of embodiments 22 or 23 wherein compression unit (G) comprises multiple compression stages.
25. System according to any one of embodiments 16 to 24, wherein a hydrogen scrubber (A′) is integrated with, or downstream to, an electrolyzer (A).
26. System according to any one of embodiments 16, 22 or 23, wherein the cleaning unit (E) is a catalyzing unit.
27. System according to embodiment 26 wherein the catalyzing unit is a de-oxo unit.
28. System according to any one of embodiments 26 or 27, comprising a pre-heating unit for water, downstream to the catalyzing unit.
29. System according to any one of embodiments 16 to 28, comprising a drying unit for removal of water.
30. System according to any one of embodiments 16 to 29, comprising at least one further cleaning unit for removing impurities from the combined streams (4,8) or (4,12).
31. Plant comprising a system according to any one of embodiments 16 to 30, for operating a process according to any of embodiments 1 to 15.

1. A process for producing synthesis gas comprising the steps of:
(a) providing a stream comprising hydrogen;
(b) providing a stream comprising carbon dioxide or a stream comprising nitrogen;
(c) combining the streams obtained in steps a) and b) into a combined stream; and
(d) cleaning said combined stream.

2. The process according to claim 1, wherein combined stream is subjected to a compression step.

3. The process according to claim 1, wherein the streams obtained in steps (a) and (b) are independently subjected to a compression (D) step, before being combined in step (c).

4. The process according to claim 1, wherein the stream comprising hydrogen is prepared by electrolysis of water.

5. The process according to claim 1, wherein the stream comprising carbon dioxide is prepared by carbon capture of a flue gas or synthesis gas.

6. The process according to claim 1, wherein the stream comprising nitrogen is prepared using air separation.

7. A system for producing synthesis gas comprising:
a) a unit for providing a stream comprising hydrogen;
b) a carbon capture unit for providing a stream comprising carbon dioxide or an air separation unit for providing a stream comprising nitrogen;
c) a cleaning unit for removal of impurities from a combined, the combined stream comprising the stream comprising hydrogen and at least one of the stream comprising carbon dioxide and the stream comprising nitrogen.

8. The system according to claim 7, wherein said unit is an electrolyzer.

9. The system according to claim 7, wherein said unit is a unit for performing chloralkali process.

10. The system according to claim 7, wherein a compression unit is upstream to the cleaning unit.

11. The system according to claim 7, wherein the cleaning unit is integrated with a compression unit.

12. The system according to claim 7, wherein the cleaning unit is arranged downstream to a last compression stage of compression.

13. The system according to claim 11, wherein compression unit comprises multiple compression stages.

14. The system according to claim 8, wherein a hydrogen scrubber is integrated with, or downstream to, the electrolyzer.

15. A plant comprising a system according to claim 7, for operating a process for producing synthesis gas comprising the steps of:
(a) providing a stream comprising hydrogen;
(b) providing a stream comprising carbon dioxide or a stream comprising nitrogen;
(c) combining the streams obtained in steps a) and b) into a combined stream; and
(d) cleaning said combined stream.
